(19) United States
(12) Patent Application Publication
(10) Pub. No.: US 2022/0222221 A1
(43) Pub. Date: Jul. 14, 2022

(54) Device and Method for Composing a File System

(71) Applicant: Huawei Cloud Computing Technologies Co., Ltd., Guizhou (CN)

(72) Inventors: Eduardo Warszawski, Hod Hasharon (IL); Saggi Mizrahi, Hod Hasharon (IL); Dima Kuznetsov, Hod Hasharon (IL)

(21) Appl. No.: 17/707,307

(22) Filed: Mar. 29, 2022

Related U.S. Application Data
(63) Continuation of application No. PCT/EP2019/076382, filed on Sep. 30, 2019.

(51) Int. Cl. G06F 16/188

(52) U.S. Cl. CPC G06F 16/188

(57) ABSTRACT

A device for providing a file system is configured to obtain a manifest related to the file system. The manifest comprises a list of component references. Each component reference indicates a component. Each component comprises one or more files and a corresponding file structure. The device is configured to provide, for each component reference in the manifest, the one or more files of that component based on the corresponding file structure, thereby composing the file system.

### CROSS-REFERENCE TO RELATED APPLICATIONS

This is a continuation of International Patent Application No. PCT/EP2019/076382 filed on Sep. 30, 2019. The disclosure of the aforementioned application is hereby incorporated by reference in its entirety.

### TECHNICAL FIELD

The present disclosure relates to the field of data processing and virtualization. More specifically, the present disclosure relates to composing a file system for example, dynamically. The present disclosure thus presents a device and method for composing a file system, and a device and method for generating a manifest.

### BACKGROUND

Some virtual machines and other computation resources rely on image files, which provide an execution environment. These image files are provided as an IMG (in computing, refers to binary files with the .img filename extension that store raw disk images of floppy disks, hard drives, and optical discs or a vector image) or International Organization for Standardization (ISO) (an ISO image is a disk image of an optical disc) file. In other words, the execution environment is provided by means of a file system. The execution environment is usually composed of discrete components, where each component provides a set of features and abilities (e.g. software packages or configuration(s)). Some solutions rely on shipping the execution environment as a single monolith image, as an ordered set of file-system layers, or execution of deployment scripts on a clean image. Further some solutions are file-system overlay, Chef or Puppet. That is, an execution environment provided for a virtual machine is precisely adapted to the purpose and demands of this virtual machine only, and cannot be adapted to other needs (where different components, features or configurations are needed).

That is, there is a lack of a solution that allows to easily adapt a file-system to different needs of one or more users.

### SUMMARY

In view of the above-mentioned problems and disadvantages, embodiments of the present disclosure aim to improve the ways of providing file systems. An objective is to provide devices and methods that allow to easily adapt a file-system to different needs of one or more users.

The objective of the present disclosure is achieved by a device for composing a file system, by a device for generating a manifest related to a file system, and corresponding methods, as described in the independent claims. Advantageous implementations are further described in the dependent claims.

In particular, embodiments of the present disclosure provide a device, which composes a file system when the file system is used, rather than when it is defined. Components that are included in the file system can be of different granularity depending on a use case. The components can be dynamically composed into the file system, when then file system is needed. The components are composed, rather than installed, into the image. No component code needs to be executed during composition of the file-system.

A first aspect of the present disclosure provides a device for composing a file system, wherein the device is configured to obtain a manifest related to the file system, the manifest comprising a list of component references, wherein each component reference indicates a component, and wherein each component comprises one or more files and a corresponding file structure; and for each component reference in the manifest, provide the one or more files of that component based on the corresponding file structure, thereby composing the file system.

This is beneficial as a given set of components can be used to create many different file systems or images. A manifest may be a data file. Manifests are much smaller in size than the sum of their components. The composition process is faster (as no code execution is required) and reproducible. Manifests provide introspection into user's images. Users are given higher level of definition for images (intent vs. result) which reduces errors and requires less expertise.

In particular, a component may be software to be provided by the file system. In particular, the component may be a packet or an application provided by the file system.

In particular, a component reference may be an indicator, which component is to be provided by the file system. In particular, a component reference may include a locator of the component (i.e. information of a location of the component to be provided by the file system).

In an implementation form of the first aspect, each component includes an archive file and the device is further configured to extract the archive file to obtain the one or more files and the corresponding file structure. This is beneficial as the one or more files and the corresponding file structure can be archived in a file, which can be used to create many different file systems or images.

In a further implementation form of the first aspect, the device is further configured to provide the one or more files, in order to compose the file system, based on at least one of the following information, which is further comprised by the component: a locator of at least one file of the component; a remote identifier of at least one file of the component; ownership information of at least one file of the component; dynamically generated data; information regarding a required user or a required group or a required Security-Enhanced (SE) LINUX policy. This is beneficial as the component comprises a variety of files, which can fulfill different needs of composing a file system.

In a further implementation form of the first aspect, the device is further configured to extract the archive file to obtain the at least one of the following information: the locator of at least one file of the component; the remote identifier of at least one file of the component; the ownership information of at least one file of the component; the dynamically generated data; and/or the information regarding a required user or a required group or a required SE LINUX policy. This is beneficial as the one or more files and the corresponding file structure can be archived in a file, which can be used to create many different file systems or images according to different needs of one or more users.

In a further implementation form of the first aspect, the device is further configured to provide access to the file system by means of a virtual file system (VFS) or to generate an image of the file system.

A second aspect of the present disclosure provides a method for composing a file system, wherein the method comprises the steps of: obtaining a manifest related to the file system, the manifest comprising a list of component references, wherein each component reference indicates a component, and wherein each component comprises one or more files and a corresponding file structure; and providing, for each component reference in the manifest, the one or more files of that component based on the corresponding file structure, thereby composing the file system.

In an implementation form of the second aspect, each component includes an archive file and the method further includes extracting the archive file to obtain the one or more files and the corresponding file structure. This is beneficial as the one or more files and the corresponding file structure can be archived in a file, which can be used to create many different file systems or images.

In a further implementation form of the second aspect, the method further includes providing the one or more files, in order to compose the file system, based on at least one of the following information, which is further comprised by the component: a locator of at least one file of the component; a remote identifier of at least one file of the component; ownership information of at least one file of the component; dynamically generated data; information regarding a required user or a required group or a required SE LINUX policy. This is beneficial as the component comprises a variety of files, which can fulfill different needs of composing a file system.

In a further implementation form of the second aspect, the method further includes extracting the archive file to obtain the at least one of the following information: the locator of at least one file of the component; the remote identifier of at least one file of the component; the ownership information of at least one file of the component; the dynamically generated data; and/or the information regarding a required user or a required group or a required SE LINUX policy. This is beneficial as the one or more files and the corresponding file structure can be archived in a file, which can be used to create many different file systems or images according to different needs of one or more users.

In a further implementation form of the second aspect, the method further includes providing access to the file system by means of a VFS or to generate an image of the file system.

A third aspect of the present disclosure provides a device for generating a manifest related to a file system, the device being configured to: receive a request for a file system, the request indicating one or more components, wherein each component comprises one or more files and a corresponding file structure, determine constraints of the one or more components indicated by the request, determine a list of components, including the one or more components indicated by the request, based on the constraints, and generate the manifest by including a list of component references, wherein each component reference indicates one component of the list of components. This is beneficial as a generated manifest can be used to create many different file systems or images. The generated manifest may be a data file. Manifests are much smaller in size than the sum of their components, thereby make the composition process faster (as no code execution is required) and reproducible. Manifests provide introspection into user's images. Users are given higher level of definition for images (intent vs. result) which reduces errors and requires less expertise.

In an implementation form of the third aspect, the list of components includes the one or more components indicated by the request, and further components selected by the device based on the constraints.

In a further implementation form of the third aspect, the constraints include at least one of the following: one or more files required by a component; one or more dependencies between files of a component and/or between components; one or more required system entities; additional required information.

A fourth aspect of the present disclosure provides a method for generating a manifest related to a file system, the method comprising: receiving a request for a file system, the request indicating one or more components, wherein each component comprises one or more files and a corresponding file structure, determining constraints of the one or more components indicated by the request, determine a list of components, including the one or more components indicated by the request, based on the constraints, and generating the manifest by including a list of component references, wherein each component reference indicates a component of the list of components.

In an implementation form of the fourth aspect, the list of components includes the one or more components indicated by the request, and further components selected by the device based on the constraints.

In a further implementation form of the fourth aspect, the constraints include at least one of the following: one or more files required by a component; one or more dependencies between files of a component and/or between components; one or more required system entities; additional required information.

The fourth aspect and its implementation forms include the same advantages as the third aspect and its respective implementation forms.

A fifth aspect of the present disclosure provides a system for providing a file system, the system comprising a device according to the first aspect and its respective implementation forms and a device according to the third aspect and its respective implementation forms, wherein the system is configured to compose and provide the file system based on the request for the file system.

The fifth aspect includes the same advantages as the first aspect and its respective implementation forms and the third aspect and its respective implementation forms.

A sixth aspect of the present disclosure provides a computer program product including computer program code, which, when executed by a processor, causes the method according to any one of the second aspect and its respective implementation forms, or any one of the fourth aspect and its respective implementation forms, to be performed.

The sixth aspect includes the same advantages as the second aspect and its respective implementation forms and as the fourth aspect and its respective implementation forms.

A seventh aspect of the present disclosure provides a non-transitory computer-readable recording medium that stores therein a computer program product which, when executed by a processor, causes the method according to any one of the second aspect and its respective implementation forms, or any one of the fourth aspect and its respective implementation forms, to be performed. The non-transitory computer-readable recording medium, comprises of one or more from the group: read-only memory (ROM), programmable ROM (PROM), erasable PROM (EPROM), Flash memory, electrically EPROM (EEPROM), and hard disk drive.

The seventh aspect includes the same advantages as the second aspect and its respective implementation forms and as the fourth aspect and its respective implementation forms.

An eighth aspect of the disclosure suggests an apparatus for composing a file system includes a processor and a memory. The memory is storing instructions that cause the processor to perform the method according to any one of second aspect and its respective implementation forms.

The eighth aspect includes the same advantages as the second aspect and its respective implementation forms.

A ninth aspect of the disclosure suggests an apparatus for generating a manifest related to a file system includes a processor and a memory. The memory is storing instructions that cause the processor to perform the method according to any one of the fourth aspect and its respective implementation forms.

The ninth aspect includes the same advantages as the fourth aspect and its respective implementation forms.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms of the present disclosure will be explained in the following description of specific embodiments in relation to the enclosed drawings, in which

FIG. 1 shows a schematic view of a device according to an embodiment of the present disclosure.

FIG. 2 shows a schematic view of an operating scenario according to the present disclosure.

FIG. 3 shows another schematic view of an operating scenario according to the present disclosure.

FIG. 4 shows another schematic view of an operating scenario according to the present disclosure.

FIG. 5 shows a schematic view of a method according to an embodiment of the present disclosure.

FIG. 6 shows a schematic view of a device according to an embodiment of the present disclosure.

FIG. 7 shows a schematic view of a method according to an embodiment of the present disclosure.

### DESCRIPTION OF EMBODIMENTS

Illustrative embodiments of method, apparatus, and program product for composing a file system are described with reference to the figures. Although this description provides a detailed example of possible implementations, it should be noted that the details are intended to be exemplary and in no way limit the scope of the application.

Moreover, an embodiment/example may refer to other embodiments/examples. For example, any description including but not limited to terminology, element, process, explanation and/or technical advantage mentioned in one embodiment/example is applicative to the other embodiments/examples.

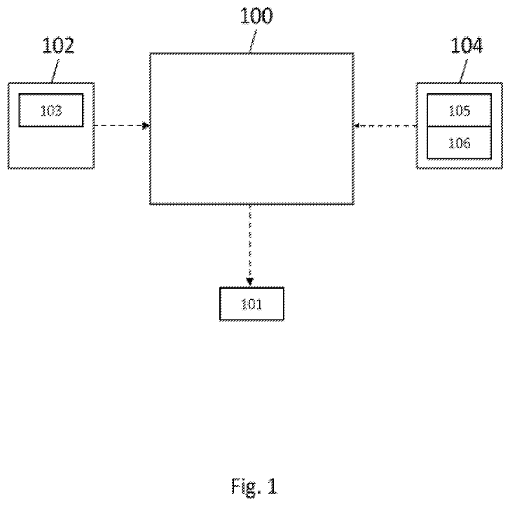

FIG. 1 shows a schematic view of a device 100 according to an embodiment of the present disclosure. The device 100 is for composing a file system 101. To this end, the device 100 is configured to obtain a manifest 102 related to the file system 101, the manifest 102 comprising a list of component references 103, wherein each component reference 103 indicates a component 104, and wherein each component 104 comprises one or more files 105 and a corresponding file structure 106. The device 100 is further configured to, for each component reference 103 in the manifest, provide the one or more files 105 of that component 104 based on the corresponding file structure 106, thereby composing the file system 101.

That is, a component 104 is a basic building block of a file system, respectively of an image (if the file system is provided as an image). Each component 104 bundles inside: files, metadata (file paths, ownership, etc.), dynamically generated data, dependencies, required system entities (users, groups, SE LINUX, SE LINUX policies), any other required information. The composed file system 101 (or image) is defined by a manifest 102 of components 104.

The manifest 102 provides a declarative definition of the contents of the file system 101 or image (what the result should look like). When a user wants to construct a file system 101 or new image, a manifest 102 is specified, which lists the components 104 the file system 101 or image should be composed of.

An image composer, which is or is included in the device 100, is responsible to convert the manifest 102 into a file system 101 or an image. The image composer ensures that all required components 104 are locally present, and composes a file system 101 out of the components. The result is guaranteed to be reproducible and identical to the declared image (on a file-level) as the composer uses the manifest 102 to create an identical layout with identical files. Components 104 are created either manually (by bundling all the attributes and files) or automatically (e.g. by running a package installation and gather the file-system delta). The following is an example of component be created automatically, a web server component may be provided by using a web server package (for instance from UBUNTU, an open source software operating system that runs from the desktop, to the cloud, to all your internet connected things). UBUNTU packages come in ‘.deb’ files that can be installed by ‘dpkg’ utility. An automatic process would be performed as: (1) Creating a clean Ubuntu environment. (2) Installing web server package with ‘dpkg’. (3) Extracting changed files and metadata from the difference between current file-system and the one present in clean environment.

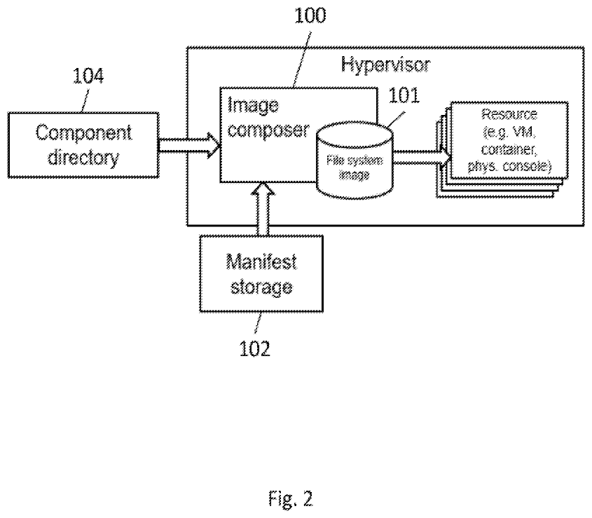

FIG. 2 shows an operating scenario of the device 100, according to an embodiment of the disclosure, which creates a file system 101 based on a manifest 102 obtained from a manifest storage (i.e. a storage which stores the manifest 102 related to the file system 101) and based on the components 104 which are obtained from a component storage (i.e. a storage which stores the component 104).

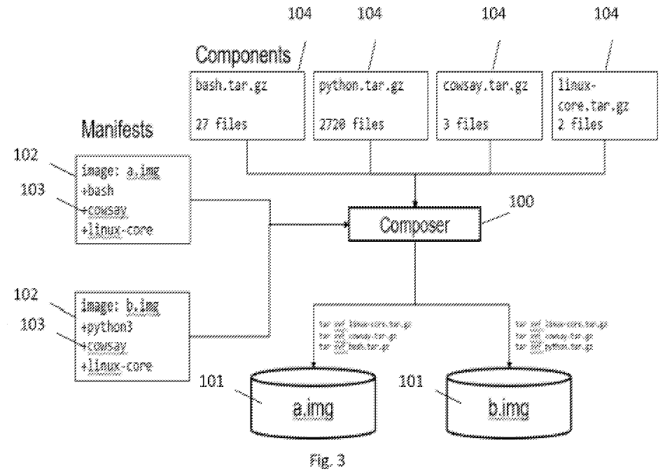

FIG. 3 show another operating scenario of the device 100. In FIG. 3 a simple composer, which is or is included in the device 100, can rely on manifests 102 that list required components 104. Each component is backed up by a tar file (e.g. the tar file is used to store the attributes such as mode, ownership of the archived files). When a composer receives a request to compose a file system 101 or an image, the following steps are performed: creating a new file system 101 or disk image; iterating the components 104 specified in the manifest 102, for each component 104: un-tar component's tar backing file into the disk image root; returning the resulting file system 101 or disk image.

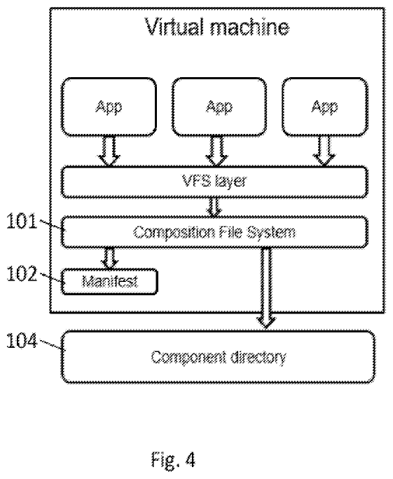

FIG. 4 shows a schematic view of an operating scenario in which the file system 101 is provided as a virtual file system. The virtual file-system utilizes information from an image manifest 102. The virtual file-system projects a file system 101 based on the components 104 listed in the manifest 102. The virtual file-system retrieves components 104 from the component directory (e.g. the component directory may be stored in the component storage).

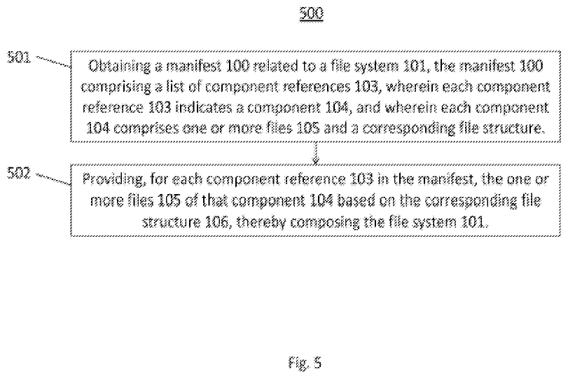

FIG. 5 shows a schematic view of a method 500 according to an embodiment of the present disclosure. The method 500 is for composing a file system 101. The method 500 comprises a step of obtaining 501 a manifest 102 related to the file system 101, the manifest 102 comprising a list of component references 103, wherein each component reference 103 indicates a component 104, and wherein each component 104 comprises one or more files 105 and a corresponding file structure. The method 500 further includes a step of providing 502, for each component reference 103 in the manifest, the one or more files 105 of that component 104 based on the corresponding file structure 106, thereby composing the file system 101.

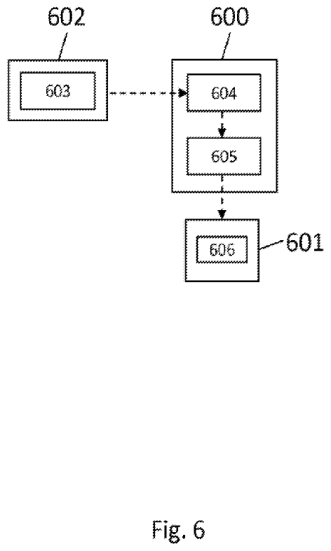

FIG. 6 shows a schematic view of a device 600 according to an embodiment of the present disclosure. The device 600 is for generating a manifest 601 related to a file system. The manifest 601 provided by the device 600 is the manifest 102 used by the device 100. The file system mentioned above is the file system 101 of FIG. 1.

The device 600 is configured to receive a request 602 for a file system, the request 602 indicating one or more components 603, wherein each component 603 comprises one or more files and a corresponding file structure. The device 600 is further configured to determine constraints 604 of the one or more components 603 indicated by the request 602. The device 600 is further configured to determine a list of components 605, including the one or more components 603 indicated by the request 602, based on the constraints 604. The device 600 is further configured to generate the manifest 601 by including a list of component references 606, wherein each component reference 606 indicates one component of the list of components 605.

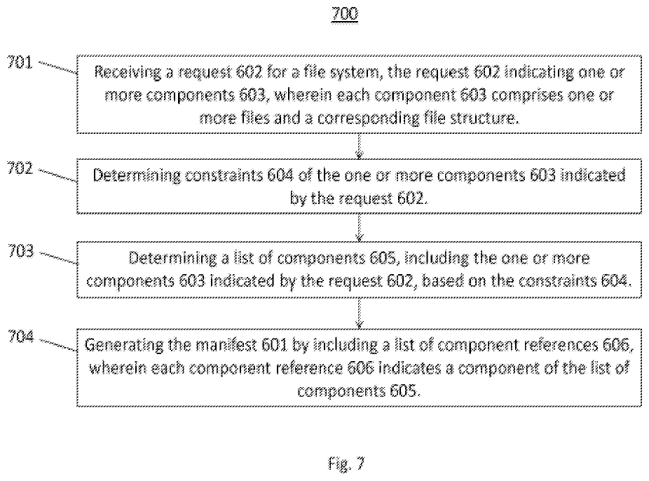

FIG. 7 shows a schematic view of a method 700 according to an embodiment of the present disclosure. The method 700 is for generating a manifest 601 related to a file system. The method 700 comprises a step of receiving 701 a request 602 for a file system, the request 602 indicating one or more components 603, wherein each component 603 comprises one or more files and a corresponding file structure. The method 700 comprises a further step of determining 702 constraints 604 of the one or more components 603 indicated by the request 602. The method 700 comprises a further step of determining 703 a list of components 605, including the one or more components 603 indicated by the request 602, based on the constraints 604. The method 700 comprises a step of generating 704 the manifest 601 by including a list of component references 606, wherein each component reference 606 indicates a component of the list of components 605.

The present disclosure has been described in conjunction with various embodiments as examples as well as implementations. However, other variations can be understood and effected by those persons skilled in the art and practicing the claimed disclosure, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant keys will be developed and the scope of the term key is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A device for composing a file system, the device comprising:
a memory configured to store instructions; and
a processor coupled to the memory and configured to execute the instructions to cause the device to:
obtain a manifest related to the file system, wherein the manifest comprises a list of component references, wherein each of the component references indicates a component, and wherein the component comprises one or more files, metadata, and a corresponding file structure; and
provide, for each of the component references, the one or more files based on the metadata and the corresponding file structure.

2. The device of claim 1, wherein each of the components further comprises an archive file, and wherein the instructions further cause the device to extract, for at least one of the component references, the archive file to obtain the one or more files and the corresponding file structure.

3. The device of claim 1, wherein the instructions further cause the device to provide, for at least one of the component references, the one or more files based on at least one of a locator of at least one of the files, a remote identifier of at least one of the files, ownership information of at least one of the files, dynamically generated data, first information regarding a required user, second information regarding a required group, or third information regarding a required Security-Enhanced (SE) LINUX policy.

4. The device of claim 3, wherein each of the components further comprises an archive file, and wherein the instructions further cause the device to extract, for the at least one of the component references, the archive file to further obtain at least one of the locator of at least one of the files, the remote identifier of at least one of the files, the ownership information of at least one of the files, the dynamically generated data, the first information regarding the required user, the second information regarding the required group, or the third information regarding the SE LINUX policy.

5. The device of claim 1, wherein the instructions further cause the device to:
provide access to the file system through a virtual file system (VFS); or
generate an image of the file system.

6. A method for composing a file system, comprising:
obtaining a manifest related to the file system, wherein the manifest comprises a list of component references, wherein each component reference indicates a component, and wherein each component comprises one or more files, metadata, and a corresponding file structure; and
providing, for each component reference, the one or more files of the component based on the metadata and the corresponding file structure.

7. The method of claim 6, wherein each component includes an archive file, and wherein the method further comprises extracting the archive file to obtain, for each component reference, the one or more files and the corresponding file structure.

8. The method of claim 6, further comprising providing, for each component reference, the one or more files based on at least one of a locator of at least one of the files, a remote identifier of at least one of the files, ownership information of at least one of the files, dynamically generated data, first information regarding a required user, second information regarding a required group, or third information regarding a required Security-Enhanced (SE) LINUX policy.

9. The method of claim 8, wherein each component further comprises an archive file, and wherein the method further comprises extracting the archive file to further obtain at least one of the locator of at least one of the files, the remote identifier of at least one of the files, the ownership information of at least one of the files, the dynamically generated data, the first information regarding the required user, the second information regarding the required group, or the third information regarding the SE LINUX policy.

10. The method of claim 6, further comprising:
providing access to the file system through a virtual file system (VFS); or
generating an image of the file system.

11. A device for generating a manifest related to a file system, the device comprising:
a memory configured to store instructions; and
a processor coupled to the memory and configured to execute the instructions to cause the device to:
receive a request for the file system, wherein the request indicates one or more components, and wherein each of the components comprises one or more files, metadata, and a corresponding file structure;
determine constraints of the one or more components;
determine, based on the constraints, a list of components including the one or more components; and
generate the manifest that includes a list of component references,
wherein each of the component references indicates one of the components.

12. The device of claim 11, wherein the list of components further includes additional components selected based on the constraints.

13. The device of claim 11, wherein the constraints include at least one of one or more of the files that are required by one of the components, one or more first dependencies between the files of one of the components, one or more second dependencies between the components, one or more required system entities, or additional required information.

14. A method for generating a manifest related to a file system, comprising:
receiving a request for the file system, wherein the request indicates one or more components, and wherein each component comprises one or more files, metadata, and a corresponding file structure;
determining constraints of the one or more components;
determining, based on the constraints, a list of components including the one or more components; and
generating the manifest that includes a list of component references,
wherein each component reference indicates one of the components.

15. The method of claim 14, wherein the list of components includes the one or more components and additional components selected based on the constraints.

16. The method of claim 14, wherein the constraints include one or more of the files that are required by one of the components.

17. The method of claim 14, wherein the constraints include one or more dependencies between the files of one of the components.

18. The method of claim 14, wherein the constraints include one or more dependencies between the components.

19. The method of claim 14, wherein the constraints include one or more required system entities.

20. The method of claim 14, wherein the constraints include additional required information.
